(19) United States
(12) Patent Application Publication
(10) Pub. No.: US 2013/0050606 A1
(43) Pub. Date: Feb. 28, 2013

(54) Liquid Crystal Lens and Liquid Crystal Display Device

(71) Applicant: Chihtsung Kang, Guangdong (CN)

(72) Inventor: Chihtsung Kang, Guangdong (CN)

(21) Appl. No.: 13/263,890

(22) PCT Filed: Sep. 5, 2011
(86) PCT No.: PCT/CN11/79338

§ 371 Date: Oct. 11, 2011

(30) Foreign Application Priority Data
Aug. 26, 2011 (CN) 201110249342.3

(51) Int. Cl. G02F 1/1335; G02F 1/13

(52) U.S. Cl. 349/57; 349/200

(57) ABSTRACT

The present invention discloses a liquid crystal lens and a liquid crystal display (LCD) device thereof, said liquid crystal lens comprises a lower layer basal plate provided with an electrode and an upper layer basal plate provided with a counter electrode, wherein the lower layer basal plate and the upper layer basal plate are mutually and oppositely arranged, and said electrode and the counter electrode are mutually insulated to form an electric field; and a liquid crystal layer arranged between said lower layer basal plate and the upper layer basal plate, wherein the liquid crystals of said liquid crystal layer are parallel positive nematic LCs; the electrode of said lower layer basal plate or the counter electrode of said upper layer basal plate is provided with convex curved structures which increase the distance between the electrode and the counter electrode. Because the liquid crystal lens is provided with convex curved structures which can increase the distance between the electrode and the counter electrode, the electric field acting on the liquid crystal layer forms the intensity gradience, so that the refractive index of the liquid crystal layer is in gradient change, and is used in the LCD to achieve the 3D display effect.

### TECHNICAL FIELD

The present invention relates to the field of lens and glassless 3D displays, particularly to a liquid crystal lens and a liquid crystal display (LCD) device.

### BACKGROUND

The existing lens are optical lens of ordinary type and the focal distances are usually constant, limiting their use in many fields. Take the field of glassless 3D displays as an example, the glassless 3D technique requires that the image signals on the panel of left and right eyes are refracted to the corresponding watching positions of left and right eyes. The familiar glassless 3D technique is that the light paths are designed for index matching by using the lenticular lens. As shown in FIG. 1, the principle of the lenticular lens is that a layer of lenticular lens 12 is provided in front of the display screen 11; so that the image plane of the display screen 11 is positioned in the focal plane of the lens, and each pixel of the image under each lenticular lens 12 is divided into several subpixels. Thus, the lens can project each subpixel in different directions; so that a watcher can watch the display screen and can see different subpixels with the two eyes from different angles, and the water can see the 3D image.

In addition to the design of the lenticular lens, there is a common design of the grin lens which use the gradience variation of refractive index. As shown in FIG. 2, as the ordinary bitoric lens, the light forms the focus with the same focal distance in the front part and the rear part through the density structure of the grin lens and the double curved surfaces of the symmetrical lens structure. However, both the focal distances of the lenticular lens and the grin lens are nonadjustable. Meanwhile, the LCD device using the lens can hardly achieve the aim of switching to the 2D image. Therefore, the existing lens can not meet the use requirement of the field of the glassless 3D displays to a certain extent.

### SUMMARY

The aim of the present invention is to provide a liquid crystal lens with gradience variation of refractive index and a LCD device which can perform 3D display and can switch the 3D display to 2D display conveniently.

The liquid crystal lens of the present invention is achieved by the following technical schemes. A liquid crystal lens comprises a lower layer basal plate provided with an electrode and an upper layer basal plate provided with a counter electrode, wherein the lower layer basal plate and the upper layer basal plate are mutually and oppositely arranged; said electrode and said counter electrode are mutually insulated to form an electric field;

and a liquid crystal layer arranged between said lower layer basal plate and said upper layer basal plate; the liquid crystals of said liquid crystal layer are parallel positive nematic LCs;

the electrode of said lower layer basal plate or the counter electrode of said upper layer basal plate is provided with convex curved structures which increase the distance between the electrode and the counter electrode.

Each said convex curved surface is a curved surface using the central peak thereof as the symmetric center.

Each said convex curved surface is in a semi-sphere structure.

Said liquid crystal lens also comprises a voltage regulating device arranged between the electrode and the counter electrode. The voltage between the electrode and the counter electrode can be dynamically regulated by the voltage regulating device to achieve the aim of dynamically regulating the focal distance of the liquid crystal lens.

The electrode of said lower layer basal plate or the counter electrode of said upper layer basal plate is provided with multiple convex curved structures which have the same shape and are arranged in parallel. Multiple focus points can be formed on one liquid crystal lens, so that the liquid crystal lens is similar to the lenticular lens used in the glassless 3D display.

The thickness of said liquid crystal layer is uniform, and an insulating layer is filled between said liquid crystal layer and the convex electrode or the counter electrode.

The purpose of the LCD device of the present invention is achieved by the following technical schemes. A LCD device comprises a liquid crystal panel and a liquid crystal lens arranged in front of the liquid crystal panel, wherein said liquid crystal lens comprises:

a lower layer basal plate provided with an electrode and an upper layer basal plate provided with a counter electrode, wherein the lower layer basal plate and the upper layer basal plate are mutually and oppositely arranged; and said electrode and said counter electrode are mutually insulated to form an electric field;

a liquid crystal layer is arranged between said lower layer basal plate and said upper layer basal plate; said liquid crystals are parallel positive nematic liquid crystals (LCs);

the electrode of said lower layer basal plate or the counter electrode of said upper layer basal plate is provided with multiple convex curved structures which have the same shape, are arranged in parallel, and increase the distance between the electrode and the counter electrode.

Preferably, each said convex curved surface is a curved surface which is in central symmetry corresponding to its peak.

Said convex curved surface is in a semi-sphere structure.

Said liquid crystal lens also comprises a voltage regulating device arranged between the electrode and the counter electrode.

The thickness of said liquid crystal layer is uniform, and an insulating layer is filled between said liquid crystal layer and the convex electrode or the counter electrode.

Because different tilting angles of the parallel positive nematic LCs are achieved in a gradient electric field, and the electrode of the lower layer basal plate or the counter electrode of the upper layer basal plate is provided with convex curved structures which increase the distance between the electrode and the counter electrode. The present invention achieves the aim of the gradient change of the electric field, and then achieves the gradient change of the refractive index of the liquid crystal lens, so that the passing light can focus. If the liquid crystal lens is used in the LCD device, it can replace the existing grin lens or the lenticular lens to achieve the 3D display effect; and the 3D display can be switched to the 2D display conveniently as long as the voltage between the electrode and the counter electrode of the liquid crystal lens is removed.

### BRIEF DESCRIPTION OF FIGURES

FIG. 1 is the schematic diagram of the optical path of the glassless 3D display technique in the prior art;

FIG. 2 is the schematic diagram of the characteristics of the grin lens;

FIG. 3 is the sectional view of a first embodiment of the present invention;

FIG. 4 is the schematic diagram of the liquid crystal molecules which are positioned in A, B and C in FIG. 3 and are tilted at different angles in the XY plane or parallel to the XY plane under the action of the electric field;

FIG. 5 is the schematic diagram of the liquid crystal molecules of one embodiment of the present invention; the liquid crystal molecules are tilted at different angles under the action of the electric field; when the polarization direction of light in X or Y direction enters into the liquid crystals, in an oblique incident included angle between the XZ plane and the incident direction, gradient refractive index change is not generated;

FIG. 6 is the schematic diagram of the liquid crystal molecules of one embodiment of the present invention; the liquid crystal molecules are tilted at different angles under the action of the electric field; the polarization direction of the light is in Y direction; when the light enters into the liquid crystals, in an oblique incident included angle between the incident direction and the ZY plane, gradience variation of refractive index is generated; and

FIG. 7 is the sectional view of the liquid crystal lens of another embodiment of the present invention.

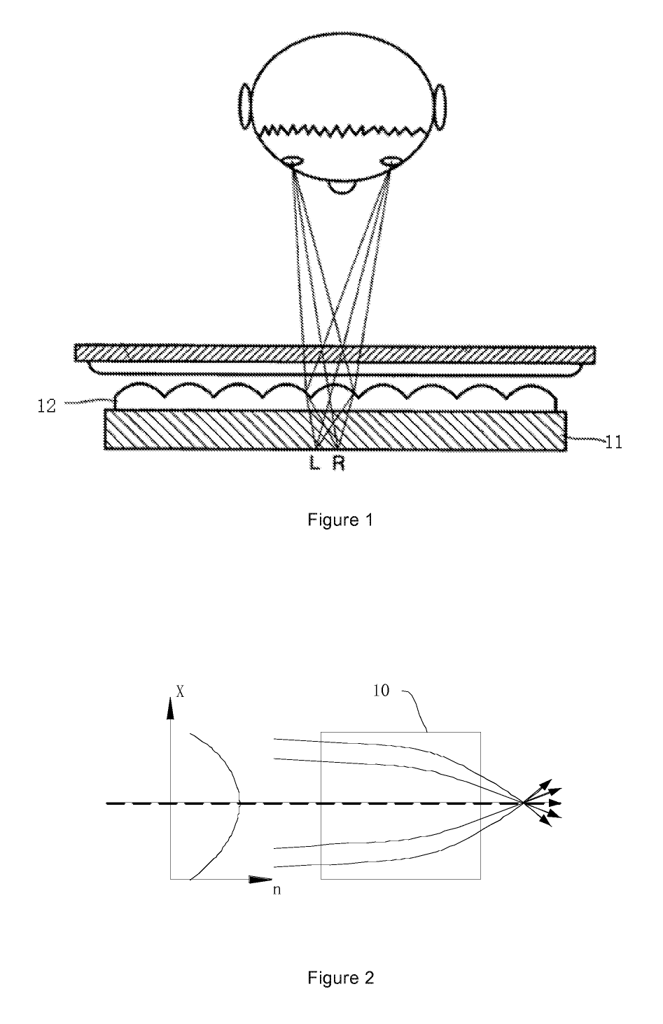

Wherein: 1. upper layer basal plate; 2. lower layer basal plate; 3. liquid crystal layer; 4. electrode; 5. counter electrode; 6. insulating layer; 81-83. liquid crystal molecules; 9. convex curved surface; 10. grin lens; 11. liquid crystal display screen; 12. lenticular lens.

### DETAILED DESCRIPTION

The present invention will further be described in detail in accordance with the figures and the preferred embodiments.

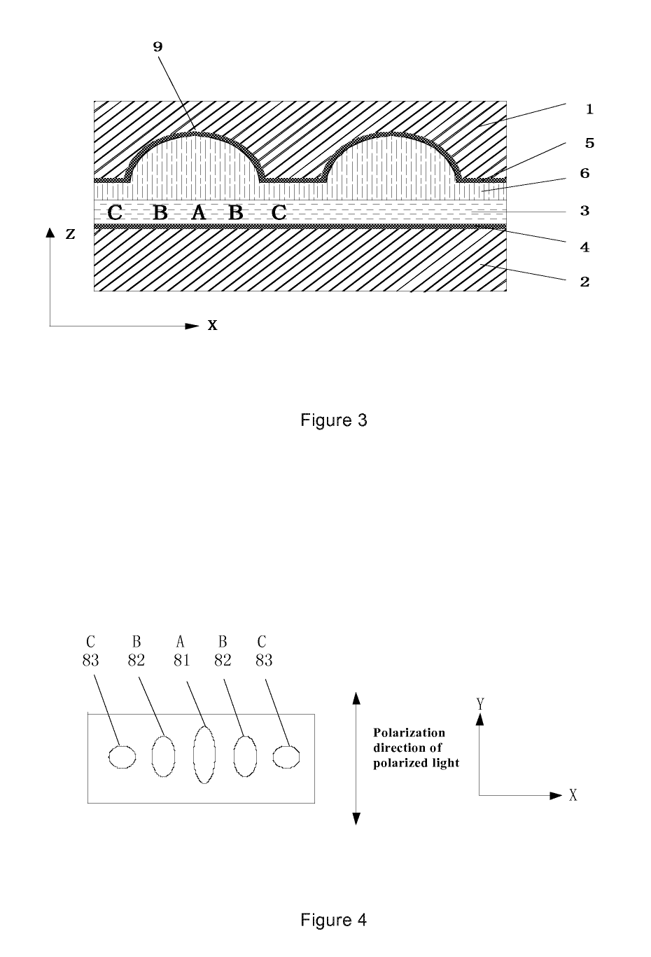

FIG. 3 is the sectional view of the liquid crystal lens of the present invention. As shown in the figure, the liquid crystal lens comprises an upper layer basal plate 1 and a lower layer basal plate 2 which is oppositely arranged to the upper layer basal plate 1, and a liquid crystal layer 3 arranged between the upper layer basal plate 1 and the lower layer basal plate 2; the inner side of the lower layer basal plate 2 is provided with an electrode 4; the inner side of the upper layer basal plate 1 is provided with a counter electrode 5 corresponding to the electrode 4; the counter electrode 5 of the upper layer basal plate 1 is insulated from the liquid crystal layer 3 through an insulating layer 6, and the insulating layer can be made of nonconductive polymeric material.

In one embodiment of the present invention, the liquid crystals of the liquid crystal layer 3 are parallel positive nematic LCs. When the voltage is imparted to the electrodes (i.e. electrode 4 and counter electrode 5) of the liquid crystal lens, the laying liquid crystal molecules are tilted under the action of the electric field so that the refractive index is changed. The size of the refractive index is related to the tilting angle. The liquid crystal molecules of the liquid crystal layer will be tilted at different angles, when different positions in the liquid crystal layer 3 are supplied with different electric field intensity; as a result, different refractive index distribution can be produced. Therefore, as long as the electrode of the lower layer basal plate or the counter electrode of the upper layer basal plate is provided with convex curved structures which increase the distance between the electrode and the counter electrode, the gradient change of the electric field can be achieved; and the gradience variation of refractive index of the liquid crystal lens can be achieved; and the passing lights can focus. When the voltage imparted to the counter electrode 5 of the upper layer basal plate 1 and the electrode 4 of the lower layer basal plate 2 is removed, the liquid crystals lie without being affected by the action of the electric field, and the liquid crystal lens does not have the gradience variation of refractive index.

The grin lens used in the glassless 3D technique has the characteristic of radial gradience variation of refractive index. The pixel can be divided into multiple subpixels by the grin lens, and subpixels can be projected into the left eye and right eye of a watcher respectively so that the 3D image is formed in the head of the watcher. However, because both the gradience variation of refractive index and the focal distance of the grin lens are constant, and because the shape of the grin lens is solid, the LCD device is not easily switched between 2D display and 3D display. Therefore, the aforementioned liquid crystal lens be used in the field of the glassless 3D technique to simulate the grin lens by using the change of the refractive index of the liquid crystals in the electric field, namely the effect of the gradience variation of refractive index is achieved by using the change of the positions of the liquid crystal molecules of the liquid crystals, so that the glassless 3D display effect is achieved.

The structure of the liquid crystal lens can be described by using the liquid crystal lens used in the LCD device for glassless 3D display as an example.

### Embodiment 1

The LCD device for glassless 3D display comprises a liquid crystal panel and a liquid crystal lens arranged in front of the liquid crystal panel. The structure of the first embodiment of said liquid crystal lens is shown in FIG. 3. The counter electrode 5 of the upper layer basal plate 1 of said liquid crystal lens is provided with multiple convex curved structures 9 which have the same shape, are arranged in parallel, and increase the distance between the electrode and the counter electrode; the curved structure are symmetrical relative to the peak and are in the semi-sphere structure; correspondingly, the side of the upper layer basal plate 1 facing said counter electrode 5 is provided with concave matching structure as that of the convex curved structures 9. The thickness of said liquid crystal layer is uniform, and the insulating layer 6 is filled between said liquid crystal layer and the convex counter electrode 5 so that the counter electrode 5 is insulated from the liquid crystal layer 3. Because of the convex curved structures 9, the intensity of the electric field formed by the counter electrode 5 and the electrode 4 has gradient change. When incident light enters the liquid crystal lens, the polarization direction of said incident light is parallel to the plane of the liquid crystal molecules of said liquid crystal layer which are tilted under the action of said electric field; and the polarization direction of said incident light is parallel to the direction of the liquid crystal molecules which are not tilted or has weight in the direction.

As shown in FIG. 3 and FIG. 4, by the design of the ITO electrode of said lower layer basal plate 2, the liquid crystal molecules of the liquid crystal layer 3 are tilted to the YZ plane under the action of the electric field (FIG. 3 does not show the Y-axis; and FIG. 4 only shows the view after the liquid crystal molecules are tilted in the XY plane); the intensity of the electric field in region A is the minimum because the distance between the electrodes is the maximum, and the liquid crystal molecule 81 of the weak electric field area in the region A is not tilted basically (take one liquid crystal molecule 81 in the region A of the liquid crystal layer 3 as an example, and other liquid crystal molecules in the region A are in parallel to the liquid crystal molecule 81 of the weak electric field area); because the electric field intensity of the region B is slightly higher than that of the region A, the liquid crystal molecule 82 of the electric field area in the region B is tilted (take one liquid crystal molecule 82 of the electric field area in the region B of the liquid crystal layer 3 as an example, and other liquid crystal molecules in the region B are in parallel to the liquid crystal molecule 82 of the electric field area); because the electric field intensity of the region C is slightly higher than that of the region B, the liquid crystal molecule 83 of the strong electric field area in the region C is tilted and its tilting angle is larger than that of the liquid crystal molecule 82 in the region B (take one liquid crystal molecule 83 of the strong electric field area in the region C of the liquid crystal layer 3 as an example, and other liquid crystal molecules in the region C are in parallel to the liquid crystal molecule 83 of the strong electric field area). Therefore, within the space, the intensity of electric field displaces gradient change; the liquid crystal molecules of the liquid crystal layer 3 arranged in the electric field are tilted, with the tilting angles in gradient change from the region A to the region C; and then the gradience variation of refractive index is formed in the direction from the region A to the region C.

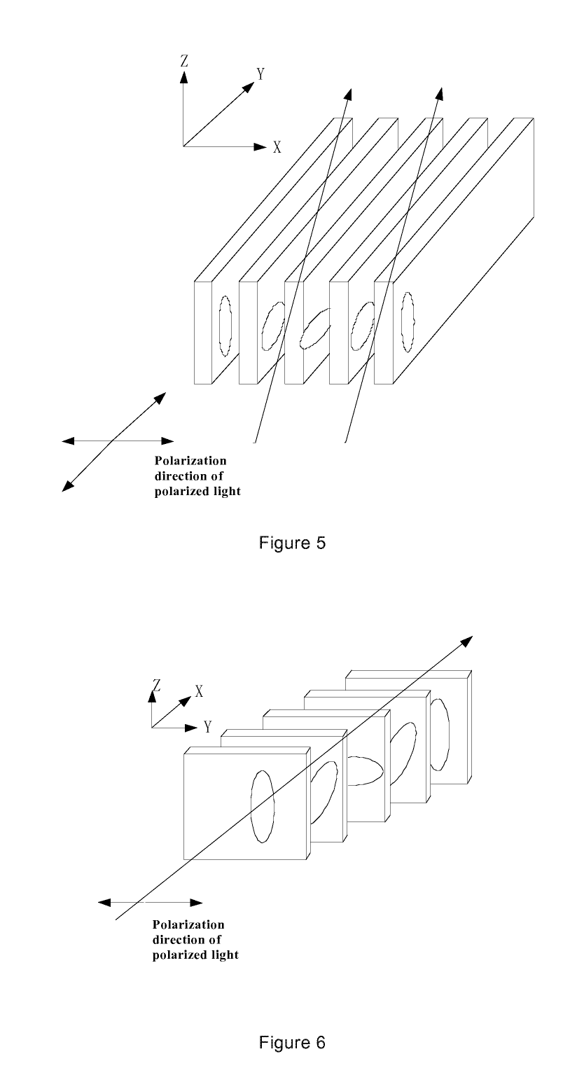

Take the liquid crystal lens shown in FIG. 3 as an example. The liquid crystal molecules are tilted at different angles along the YZ plane or parallel to the YZ plane under the action of the electric field (as shown in FIG. 5); when the light enters with an oblique incident included angle between the XZ plane and the incident direction, the incident light only has a single refractive index, no matter the polarization direction is in the X direction or in the Y direction. As shown in FIG. 6, when the light enters with oblique incident included angle between the ZY plane and the incident direction, the polarization direction of the incident light is in the Y direction or has weight in the Y direction, and the gradient change of the refractive index can be formed.

Specially, as shown in FIG. 3, if the counter electrode 5 of the upper layer basal plate 1 is designed with the convex curved structures 9, the insulating layer is arranged between the counter electrode 6 and the liquid crystal layer 3 so that the counter electrode 5 is insulated from the liquid crystal layer 3; the lower layer basal plate 2 and the electrode 4 thereof are designed in a plane mode; the liquid crystal layer 3 are provided with the parallel positive nematic LCs; the liquid crystal molecules lie horizontally when they are not affected by the electric field; and the design of the electrode of the lower layer basal plate 2 makes the liquid crystals tilt in the YZ plane or parallel to the YZ plane under the action of the electric field. When the light selected by the polaroid is incident, the polarization direction of said incident light is parallel to the Y direction or has weight in the Y direction; the gradient change of the refractive index as that in the grin lens can be formed; and the light can produce focusing effect in the X direction.

### Embodiment 2

The structure of the liquid crystal lens of the embodiment 2 is similar to that of the embodiment 1. As shown in FIG. 3, the counter electrode 5 of the upper layer basal plate 1 is designed with the convex curved structures 9; the insulating layer is arranged between the electrode 5 and the liquid crystal layer 3 so that the counter electrode is insulated from the liquid crystal layer 3; and the lower layer basal plate 2 and the electrode 4 thereof are arranged in plane mode. The liquid crystals are provided with parallel positive nematic LCs; the liquid crystal molecules lie levelly when they are not affected by the electric field. When incident light enters the liquid crystal lens, the polarization direction of said incident light is parallel to the tilting plane of the liquid crystal molecules in said liquid crystal layer under the action of said electric field, and the polarization direction of said incident light is parallel to the direction of the liquid crystal molecules which are not tilted or has weight in the direction. Different from that of the embodiment 1, by the design of the ITO electrode of said lower layer basal plate 2, the liquid crystal molecules tilt in the XZ plane or parallel to the XZ plane under the action of the electric field. When the light selected by the polaroid enters enters, the polarization direction of said incident light is parallel to the X direction, or has weight in the X direction; the gradience variation of refractive index as that of the grin lens can be formed, and the light can produce focusing effect in the Y direction.

### Embodiment 3

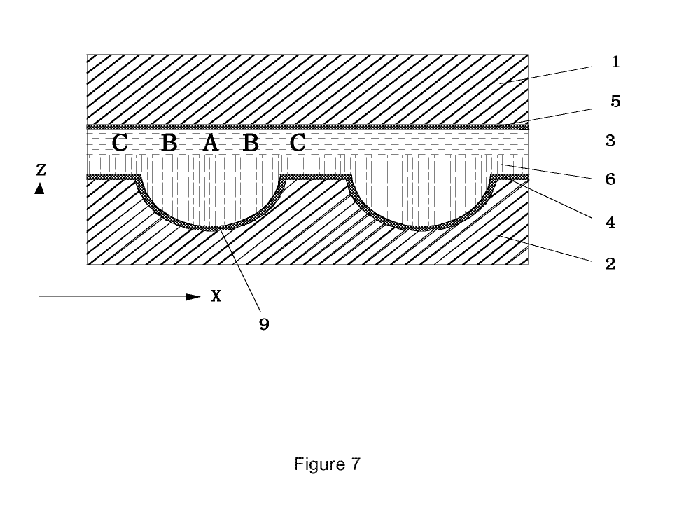

The structure of the liquid crystal lens of the embodiment 3 is similar to that of the embodiment 1, and is different from that of the embodiment 1 in that, as shown in FIG. 7, the electrode 4 of the lower layer basal plate 2 is provided with convex curved structures 9 which increase the distance between the electrode and the counter electrode. Correspondingly, the side of the lower layer basal plate 2 facing said electrode 4 is provided with concave regions with the same structure as that of the convex curved structures 9. The thickness of said liquid crystal layer is uniform, and the insulating layer 6 is filled between said liquid crystal layer and the convex electrode 4 so that the electrode 4 is insulated from the liquid crystal layer 3. The upper layer basal plate 1 and the counter electrode 5 thereof are arranged in a plane mode. The liquid crystals are parallel positive nematic LCs. The liquid crystal molecules lie levelly when they are not affected by the electric field. When incident light enters the liquid crystal lens, the polarization direction of said incident light is parallel to the plane of the liquid crystal molecules of said liquid crystal layer which are tilted under the action of said electric field, and is parallel to the direction of the liquid crystal molecules which are not tilted or has weight in the direction. The design of the counter electrode 5 of the upper layer basal plate 1 makes the liquid crystal molecules tilt in the YZ plane or parallel to the YZ plane under the action of the electric field. When the light selected by the polaroid enters, only the polarization direction of said incident light is parallel to the Y direction or has weight in the Y direction; the gradience variation of refractive index as that of the grin lens can be formed, and the light can produce focusing effect in the X direction.

### Embodiment 4

The structure of the liquid crystal lens of embodiment 4 is similar to that of the embodiment 3. As shown in FIG. 7, the electrode 4 of the lower layer basal plate 2 is provided with convex curved structures 9; the insulating layer is arranged between the electrode 4 and the liquid crystal layer 3 so that the electrode 4 is insulated from the liquid crystal layer 3; and the upper layer basal plate 1 and the counter electrode 5 thereof are arranged in a plane mode. The liquid crystals are parallel positive nematic liquid crystals (Positive Nematic LCs); the liquid crystal molecules lie levelly when they are not affected by the electric field. When incident light enters the liquid crystal lens, the polarization direction of said incident light is parallel to the plane of the liquid crystal molecules of said liquid crystal layer which are tilted under the action of said electric field, and is parallel to the direction of the liquid crystal molecules which are not tilted or has weight in the direction. Different from that of the embodiment 3, the design of the counter electrode 5 of the upper layer basal plate 1 makes the liquid crystal molecules tilt in the XZ plane or parallel to the XZ plane under the action of the electric field. When the light selected by the polaroid enters, the polarization direction of said incident light is parallel to the X direction or has weight in the X direction; the gradience variation of refractive index as that of the grin lens can be formed, and the light can produce focusing effect in the Y direction.

In the present invention, the electrode or the counter electrode of the liquid crystal lens is provided with multiple parallel and gradually convex curved structures with equal distance between each two columns, like the lenticular lens used in the existing 3D display device. Of course, the convex curved structures can be divided into multiple rows additionally, and can also be divided into multiple rows and multiple columns if the liquid crystal lens is large enough.

Because the tilting angle of the liquid crystal molecules is related to the intensity of the electric field, the refractive index with different gradient changes can be obtained by imparting different voltages to the electrodes of the liquid crystal lens, namely the liquid crystal lens can be focalized. Said liquid crystal lens also comprises a voltage regulating device (not shown in the figure) arranged between the electrode and the counter electrode, and the voltage between the electrode and the counter electrode can be dynamically regulated by the voltage regulating device to achieve the aim of dynamically regulating the focal distance of the liquid crystal lens.

The liquid crystal lens can be used in the LCD, namely the liquid crystal lens is arranged on the image plane of the liquid crystal panel. Thus, the lenticular lens or the grin lens used by the existing 3D display device can be replaced, so that the LCD can display 3D images. Meanwhile, the 3D display device using the liquid crystal lens can display 2D images. When 2D image is required to be displayed without displaying the 3D image, the voltage imparted to the electrode of the liquid crystal lens can be removed, so that the liquid crystal lens can not form the refractive index with gradient change; namely the liquid crystal lens is the same as the ordinary light transmitting glass. Said liquid crystal lens can also be used in other fields as long as the convex curved structures are adaptably designed. For example, the liquid crystal lens can replace the optical lens in a camera, and can change the focal distance by regulating the voltage.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A liquid crystal lens, comprising: a lower layer basal plate provided with an electrode, and an upper layer basal plate provided with a counter electrode, the lower layer basal plate and the upper layer basal plate are mutually and oppositely arranged, and said electrode and the counter electrode are mutually insulated to form an electric field; and a liquid crystal layer arranged between said lower layer basal plate and the upper layer basal plate, the liquid crystals (LCs) of said liquid crystal layer are parallel positive nematic LCs; the electrode of said lower layer basal plate or the counter electrode of said upper layer basal plate is provided with convex curved structures which increase the distance between the electrode and the counter electrode.

2. The liquid crystal lens of claim 1, wherein said convex curved structures are of central symmetry corresponding to its peak.

3. The liquid crystal lens of claim 2, wherein each said convex curved structure is of semi-sphere structure.

4. The liquid crystal lens of claim 1, wherein said liquid crystal lens also comprises a voltage regulating device arranged between the electrode and the counter electrode.

5. The liquid crystal lens of claim 1, wherein the electrode of said lower layer basal plate or the counter electrode of said upper layer basal plate is provided with multiple convex curved structures which have the same shape and are arranged in parallel.

6. The liquid crystal lens of claim 2, wherein the electrode of said lower layer basal plate or the counter electrode of said upper layer basal plate is provided with multiple convex curved structures which have the same shape and are arranged in parallel.

7. The liquid crystal lens of claim 1, wherein the thickness of said liquid crystal layer is uniform, and an insulating layer is arranged between said liquid crystal layer and the convex electrode or the counter electrode.

8. A liquid crystal display (LCD) device, comprising: a liquid crystal panel, and a liquid crystal lens arranged in front of the liquid crystal panel; said lens comprises
a lower layer basal plate provided with an electrode and an upper layer basal plate provided with a counter electrode, the lower layer basal plate and the upper layer basal plate are mutually and oppositely arranged, and said electrode and the counter electrode are mutually insulated to form an electric field;
a liquid crystal layer arranged between said lower layer basal plate and the upper layer basal plate, said liquid crystals are parallel positive nematic LCs;
the electrode of said lower layer basal plate or the counter electrode of said upper layer basal plate is provided with multiple convex curved structures which have the same shape, are arranged in parallel, and increase the distance between the electrode and the counter electrode.

9. The LCD device of claim 8, wherein each said convex curved structure is of central symmetry corresponding to its peak.

10. The LCD device of claim 9, wherein each said convex curved structure is of a semi-sphere structure.

11. The LCD device of claim 8, wherein said liquid crystal lens also comprises a voltage regulating device arranged between the electrode and the counter electrode.

12. The LCD device of claim 8, wherein the thickness of the liquid crystal layer is uniform, and an insulating layer is arranged between said liquid crystal layer and the convex electrode or the counter electrode.
